(19) United States
(12) Patent Application Publication
(10) Pub. No.: US 2008/0300965 A1
(43) Pub. Date: Dec. 4, 2008

(54) METHODS AND APPARATUS TO MODEL SET-TOP BOX DATA

(76) Inventor: Peter Campbell Doe, Ridgewood, NJ (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/100,953

(22) Filed: Apr. 10, 2008

Related U.S. Application Data
(60) Provisional application No. 60/941,130, filed on May 31, 2007.

(51) Int. Cl. G06F 17/18; G06F 17/30

(52) U.S. Cl. 705/10; 702/181

(57) ABSTRACT

Methods and apparatus to model set-top box data are disclosed. An example method includes receiving a first set of non-panelist behavior data and receiving a second set of panelist set-top box behavior data, the second set being associated with demographic data. The example method also includes identifying at least one behavior pattern common to the first and second sets of behavior data, and fusing data associated with the at least one behavior pattern from the first set with data associated with the at least one behavior pattern from the second set to impute at least one demographic characteristic from the second set to the first set and generate a quantity of household tuning minutes.

### RELATED APPLICATIONS

This patent claims the benefit of U.S. provisional application Ser. No. 60/941,130, filed on May 31, 2007, which is hereby incorporated by reference herein in its entirety.

### FIELD OF THE DISCLOSURE

This disclosure relates generally to market research, and, more particularly, to methods and apparatus to model set-top box data.

### BACKGROUND

Understanding audience behavior allows marketing entities to more effectively target the audience with marketing materials that are likely to have an impact. For example, understanding that one or more audience members prefer to watch travel related television programming may cause a marketing entity to assume those audience members are interested in travel content and, thus, may cause them to supply marketing materials focused on travel to those members. However, the audience member(s)' interest in travel related television programming may not be associated with an interest in travel, but may instead be more associated with a related interest, such as photography, international cooking, or real-estate. Thus, advertisements associated with travel may not necessarily be of interest to the audience member(s).

In addition to audience behavior, understanding audience demographics allows a marketing entity to generate additional conclusions and/or valid assumptions about an audience member's preferences and/or interests. Therefore, a greater confidence in a specifically tailored marketing campaign may result when both audience behavior and corresponding demographic information is available. For example, knowing both demographic information and an observed audience behavior of watching travel related television programming may allow the marketing entity to apply observed trends to the audience member(s). For instance, if the zip code of the audience member is known, then one or more observed trends related to audience members of that zip code (e.g., average income) may result in advertisements tailored to high-end or economy travel vacation packages, for example.

To acquire audience demographic information, marketing entities may employ a people meter device. The people meter is typically a small device carried by an audience member (e.g., on a belt) and/or placed near a television set and/or set-top box of the household. The demographic information may include identity-based information about the current viewer, such as name, age, sex, income, etc. People meter devices are typically provided to a household based on the household member's agreement to participate in viewing habit research initiatives, thus this demographic information is readily available. However, due to cost and/or administrative constraints, providing a people meter to every audience member and/or placing a people meter in every household that also has a set-top box is typically not practical.

### BRIEF DESCRIPTION OF THE DRAWINGS

FIG. 1 is a block diagram of an example system configured to model set-top box data.

FIG. 2 is a more detailed illustration of the example deletion factor engine of FIG. 1.

FIG. 3 illustrates a table of example retention rules.

FIG. 4 is a more detailed illustration of the example characteristics imputation engine of FIG. 1.

FIG. 5 is a more detailed illustration of the example viewing probability engine of FIG. 1.

FIG. 6 is a portion of a quarter-hour viewing segment calculated by the example characteristics imputation engine of FIG. 1.

FIG. 7 is a portion of an audience calculation calculated by the example characteristics imputation engine of FIG. 1.

FIGS. 8-11 are flowcharts representative of example machine readable instructions that may be executed to implement the example system of FIG. 1.

FIG. 12 is a block diagram of an example processor system that may be used to execute the example machine readable instructions of FIGS. 8-11 to implement the example system of FIG. 1.

### DETAILED DESCRIPTION

While a set-top box in a household may contain the requisite processing capabilities to monitor, store, and transmit viewing habit data to a marketing entity, the marketing entity is generally prohibited from acquiring private information from the set-top box unless the household member(s) agree to such data acquisition. However, the marketing entity may still acquire viewer activity devoid of any personalized information. For example, any information associated with the household zip code, address, and/or any other derived identification information based on a set-top box serial number is removed from and/or not collected with viewer behavior data, such as channel changes, volume changes, and/or channel viewing duration information collected at the set-top box (STB) of a household that has not agreed to provide access to its personal information. Accordingly, audience member privacy is maintained, but the collected data may be less useful to the marketing entity without the associated demographics information.

Marketing entities and/or media researchers typically consider the possibilities of using data collected at or with set-top boxes to be promising, but must acknowledge that privacy concerns temper their ability to fully exploit these set-top box capabilities. Such privacy concerns arise from laws to protect consumer privacy, such as Title VII of the Telecommunications Act of 1996. In addition to such statutory regulations, household members typically disfavor acquisition of their behavioral information when it is explicitly associated with their identity and/or when their identity may be derived by way of a set-top box serial number and associated subscriber account lookup.

A set-top box installed by a service provider (e.g., a cable-television service provider, a satellite-television service provider, etc.) may include a unique serial number that, when associated with subscriber information, allows a media researcher (e.g., The Nielsen Company®) and/or a marketing entity to ascertain specific subscriber behavior information. To comply with state and/or federal laws related to consumer privacy, and/or to comply with general consumer preferences, the media researcher must not make such associations and/or must not acquire personalized consumer data (e.g., demographic information such as name, age, sex, geographic locality, income, etc.) unless explicit consumer consent has been received. Such consumer consent may be obtained, for example, by contacting statistically selected households and requesting that they agree to have their television and/or other media behaviors monitored. Behavior data without associated demographic information is relatively less useful to the media researcher(s), and may not allow the media researcher(s) to accurately project and/or extrapolate consumer viewing trends, broadcast programming popularity, and/or advertising effectiveness.

On the other hand, utilization of statistically selected households allow the media researcher and/or the marketing entity to collect and study viewing behavior for demographic groups of interest. Participating households may have monitoring equipment installed to record and transmit viewer activities such as selected channels, channel changes, volume changes, time-of-day viewing measurements, etc. The monitoring equipment may also include a people-meter, such as the Nielsen People Meter® by The Nielsen Company, to allow each household member to identify when he or she is watching television. Combinations of viewer behavior and demographic parameters voluntarily provided by the statistically selected households permit the media researcher(s) to accurately project and/or extrapolate consumer viewing trends, broadcast programming popularity, and/or advertising effectiveness to a larger population of interest (e.g., a larger universe).

Establishing and maintaining statistically selected households to assure reliable demographic projections may require significant financial investment by the media researcher. Each selected household may require one or more visits by a service person to install audience monitoring equipment and/or people meter interface device(s). Additionally, the selected household(s) are replaced over time (e.g., after approximately two-years), thereby requiring additional financial resources to locate a suitable replacement household within the demographic profile of interest. However, while such statistically selected households allow the media researcher to make predictions with an acceptable degree of confidence, the methods and apparatus described herein permit the acquisition and use of non-panelist set-top box behavior data (i.e., data from set-top boxes that are not associated with a People Meter® and/or not associated with a statistically selected household) from households that have not agreed to participate in a study (i.e., non-panelist households) without acquiring any personalized consumer data, thereby maintaining consumer privacy. As described in further detail below, additional behavior data retrieved from such non-panelist set-top boxes may improve the confidence and reliability of viewer behavior monitoring and predictions without the need to increase the number of panelist households.

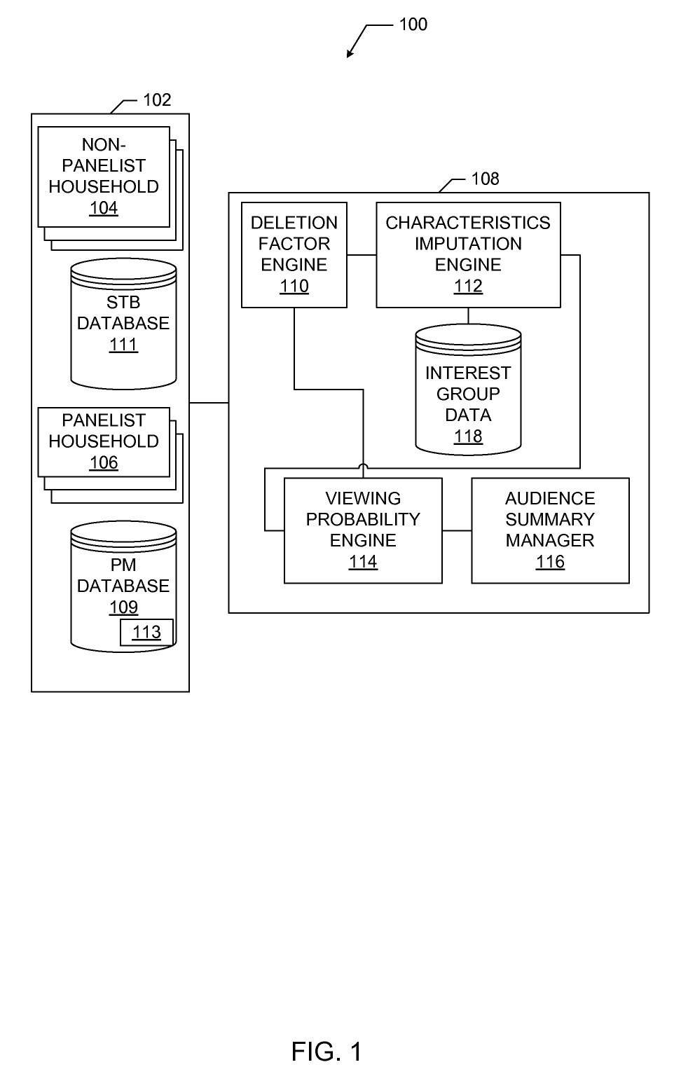

FIG. 1 is a schematic illustration of an example system 100 to facilitate set-top box modeling using data from panelist households (e.g., households that have a people meter) and non-panelist households (e.g., households that have an STB, but no people meter), the system 100 does not acquire and/or otherwise obtain personalized consumer data (e.g., demographic data from the non-panelist households). In the illustrated example of FIG. 1, the system 100 includes a set of households 102 fiat include a first subset of non-panelist households 104 households with STBs only), and a second subset of panelist households 106 (e.g., households that have agreed to be monitored and, thus, have both an STB and People Meter® (PM)). The second set of households 106 are statistically selected to participate in an audience measurement study and provide both behavior data (e.g., channel changes, volume changes, time-of-day viewing information, etc.) and personalized consumer data (e.g., demographic data related to the household). However, the first set of households, while capable of providing behavior data (e.g., selected channel, time-of-day channel information, volume change, etc.) are not selected and/or otherwise identified based on any information that could lead to identification of the corresponding household demographics. Instead, the example first set of households 104 may be pooled in one or more storage mediums in a random fashion. Thus, the first set of households 104 are non-panelist households and the second set of households 106 are panelist households.

The data collected from the STBs of the non-panelist households 104 and/or the panelist households 106 may be stored in one or more memory devices, such as one or more databases. Data collected from the non-panelist household STBs 104 includes behavior information such as, but not limited to, dates and times of viewing a selected channel, set-top box power status (e.g., On/Off), volume changes, channel changes, etc. While each non-panelist household STB 104 may include an associated unique serial number and/or other unique identification number, any such information is removed, discarded, or not retrieved from the non-panelist household STBs 104. Accordingly, the data retrieved from the non-panelist household STBs 104 only contain behavior information, but no information related to demographics and/or an identification sequence that could potentially allow the non-panelist household identity to be derived through subscriber records.

The household members of panelist households 106 agree to have their behavior monitored and associated with demographic information. Due to, in part, cost and administrative constraints, the number of participating panelist households 106 is substantially less than the number of non-panelist households 106. For example, a media researcher may select a panelist household based on its Hispanic ethnicity. The household members of such selected panelist households 106 agree to disclose their ages, presence of children, income, education, profession, geographic location, zip code, etc. Additionally, because the selected panelist households' location(s) are known, the media researcher has address information (e.g., city, state, street, zip code, zip code +4, etc.) that may allow projections/predictions to other audience members in that region/location. Knowledge of the household state and/or zip code, for example, may allow a media researcher to consult the U.S. Census Bureau to estimate personal income per capita, population density, and/or median values of owner-occupied housing units.

The example system 100 of FIG. 1 also includes a viewing data model engine 108. As described in further detail below, the example viewing data model engine 108 employs multiple stages to generate viewing data and viewing probabilities (sometimes referred to as viewing factors) using both people meter data from a people meter database 109 (PM database) (e.g., demographics data) and set-top box data from, for example, a set-top box database 111 (e.g., including behavior data). As described above, the STB data from the panelist households 106 includes associated demographics information, which permits the media researcher to project and/or extrapolate consumer viewing trends, broadcast programming popularity, and/or advertising effectiveness. However, the STB data from the non-panelist households 104, which may also be stored in the STB database 111, does not include any association to corresponding demographics data and, thus, is not typically deemed appropriate for projections and/or extrapolations to a larger universe. As discussed in further detail below, the example viewing model engine 108 facilitates at least one method to utilize the behavior data from non-panelist STBs, devoid of associated demographics information, for generation of viewing probabilities.

In the illustrated example of FIG. 1, the viewing data model engine 108 includes a deletion factor engine 110, a characteristics imputation engine 112, and a viewing probability engine 114. The example deletion factor engine 110, characteristics imputation engine 112, and the viewing probability engine 114 are communicatively connected to the non-panelist households 104, and communicatively connected to the panelist households 106 via, for example, store information in one or more databases, such as the PM database 109 and the STB database 111. An audience summary manager 116 is communicatively connected to the viewing probability engine 114 to provide a user with formulas, charts, tables, and/or other formatted output indicative of audience viewing probability information.

Generally speaking, the example deletion factor engine 110 facilitates application of one or more rules to allow deletion of all or part of a viewing session. For example, a two-hour viewing session recorded by the first or second sets of households 104, 106 that occurs during prime-time viewing hours is more likely to be associated with actual viewing. However, a separate two-hour viewing session that occurs between the hours of 1:00 A.M. and 3:00 A.M. is more likely the result of an STB that was intentionally or inadvertently left on. As such, the example deletion factor engine 110 applies one or more deletion factors to a viewing session, as described in further detail below.

Also described in further detail below, the example characteristics imputation engine 112 facilitates, in part, identification of one or more characteristic behavior patterns and data fusion. As shown in the illustrated example of FIG. 1, the characteristics imputation engine 112 accesses interest group data via the interest group database 118 that may include characteristic behavior patterns from alternate sources (i.e., sources other than STBs and/or PMs). The example viewing probability engine 114, in part, generates one or more viewing probabilities based on data fusion(s) executed by the characteristics imputation engine 112. Viewing probabilities generated by the example viewing probability engine 114 are processed by the example audience summary manager 116 to, in part, calculate audiences, calculate ratings, and/or to calculate reach.

Additionally, an interest group data source 118 is communicatively connected to the characteristics imputation engine 112 to, in part, allow the user (e.g., the media researcher, the marketing entity, etc.) to perform one or more data fusions with selected population categories. For example, in the event that the user has acquired and/or developed a database related to a readership survey, such survey information may be stored in the interest group data source 118 and include information about magazines of interest, magazine purchase habits/trends, and/or demographic information related to the people that buy magazines within observed purchase habits. As explained in further detail below, the example characteristics imputation engine employs a data fusion process to impute demographic characteristics information to raw behavior-based data.

The example PM database 109 also includes a non-set-top box (non-STB) viewing data source 113 to facilitate audience modeling with respect to other television sets within a panelist household 106 that are not connected to an STB. As a result of the fact that not every television in a household 104, 106 includes an attached STB, return data from non-panelist households 104 do not necessarily provide a complete understanding of television tuning in that household. The Nielsen People Meter® (NPM), however, compiles viewing behavior related to televisions that may be in one or more other locations of the panelist household 10G, but not connected to an STB. Such televisions may be located in, for example, master bedrooms, guest bedrooms, dens, playrooms, and/or a kitchen.

The measurements of the example system 100 are based on a representative sample of several thousand (e.g., approximately 12,000) panelist households 106 in the United States. The example system 100 measures the viewing of persons (unit level) and households (a less granular level) across all televisions in the panelist household 106. Part of the measurements conducted by the system include identification of which televisions do not have a return path capability (e.g., no STB and/or PM connected thereto). Viewing on such non-connected televisions, as derived from, for example, one or more surveys, is stored in the non-STB viewing data source 113 of the example PM database 109. As described in further detail below, the non-STB viewing data source 113 may be employed with one or more data fusion techniques to, in part, obtain a more complete audience measurement.

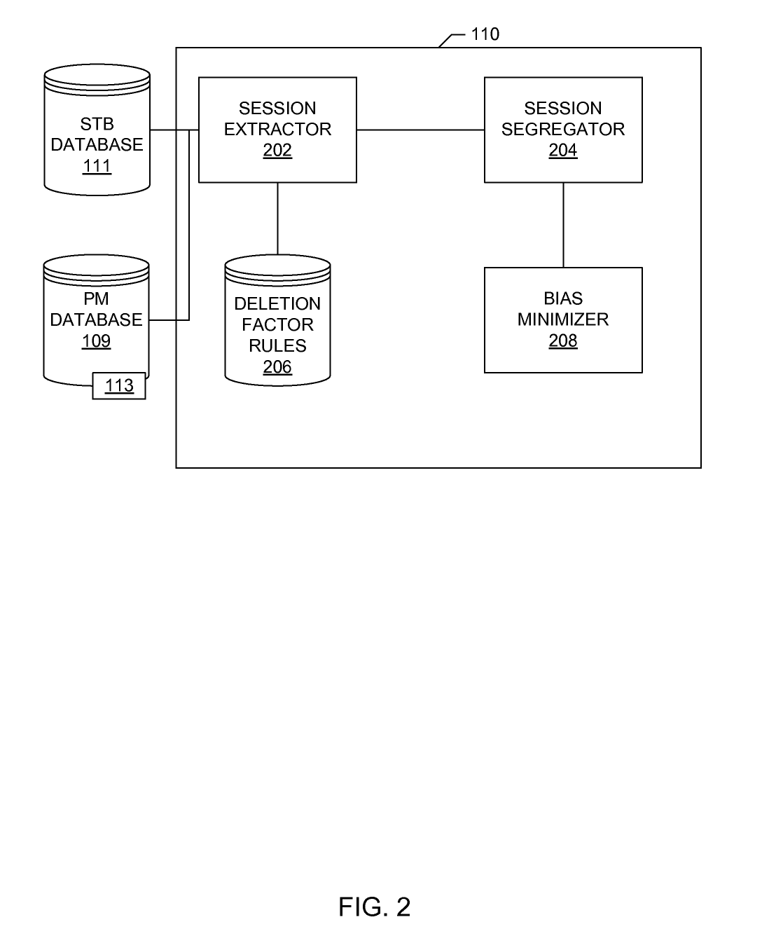

FIG. 2 is a schematic illustration of the example deletion factor engine 110 of FIG. 1. In the illustrated example of FIG. 2, the deletion factor engine 110 is communicatively connected to the household set-top box data 111 and the people meter data 109. An example session extractor 202 identifies one or more viewing sessions from each of the non-panelist households 104 represented in the set-top box data 111. A session is defined herein as a unit of time for which uninterrupted viewing by a household audience member has occurred. The example deletion factor engine 110 of FIG. 1 also includes a session segregator 204 to apply one or more rules to the one or more sessions extracted by the session extractor 202. The session segregator 204 receives one or more rules from a deletion factor rule database 206 that stores rules to be enforced/applied by the example session segregator 204. To minimize any potential bias when extracting and/or defining sessions, the example deletion factor engine 110 of FIG. 2 includes a bias minimizer 208 to, in part, apply a randomization factor to the extracted session(s).

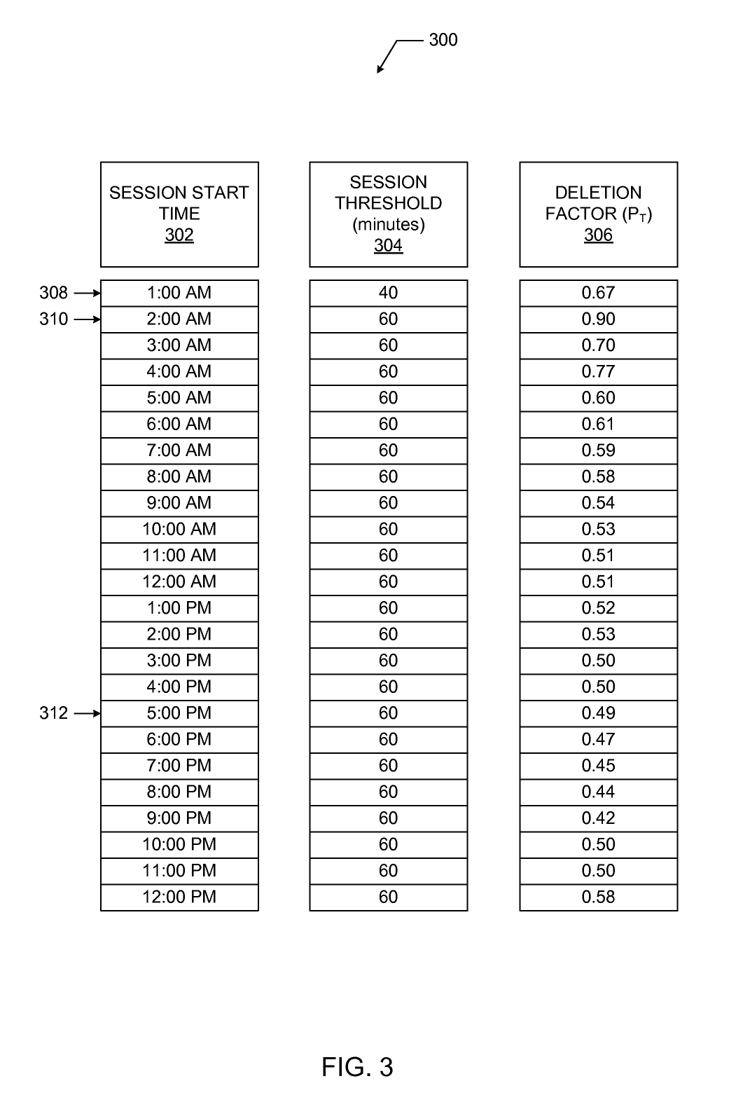

In operation, the example deletion factor engine 110 of FIG. 2 receives one or more sessions from the set-top box database 111. If the stored set-top box data within the STB database 111 includes any information indicative of a non-panelist household and/or a non-panelist subscriber identity, the example session extractor 202 filters and/or deletes such identity information. The session segregator 204 determines whether a received session and/or a portion thereof, is to be retained or discarded based on one or more rules within the deletion factor rule database 206. For example, sessions having an uninterrupted length more than 40 minutes may not be deemed worthwhile for future analysis. Additionally or alternatively, session lengths deemed worthwhile may vary based on a time-of-day, as illustrated in the example retention rule 300 of FIG. 3.

Turning briefly to FIG. 3, the example retention rule 300 includes a session start time column 302, a session duration threshold column 304, and a corresponding deletion factor column 306. In the event that the session segregator 204 receives a session from the session extractor 202 having a thirty minute duration and which started at 1 A.M., then the retention rule 300 instructs the example session segregator 204 to completely retain the whole session to indicate actual viewing has occurred (see row 308). On the other hand, in the event that the session segregator 204 receives a session from the session extractor 202 having a duration of more than forty minutes and a start time of 1 A.M., then the retention rules 300 instruct the example session segregator 204 to apply a deletion factor of 0.67.

Generally speaking, deletion factors tend to be higher for sessions that occur during late night and early morning hours based on, in part, an expectation that most household members will be sleeping. Some households may turn off a television upon bedtime, but may intentionally or inadvertently leave the set-top box powered on throughout the night. As a result, actual broadcast program consumption (e.g., actively watching a broadcast pronoun) has not necessarily occurred just because the set-top box was powered-on and tuned to a particular channel. Deletion factors that are higher, such as the example deletion factor of 0.90 (see row 310) shown in the retention rules 300 of FIG. 3, illustrate a greater likelihood that the household member may have simply fallen asleep while the television and/or set-top box was powered-on.

Rules 206 (see FIG. 2) related to deletion factor 306, session length 304, and/or associated session start time(s) 302 may be based on information gathered from empirical PM observations. For instance, the deletion factor(s) may be determined and/or designed, in part, based on people meter data showing that audience members frequently leave the set-top box tuned to a channel, but fail to depress a corresponding PM button to indicate active viewing during the early morning hours.

In the illustrated example of FIG. 2, the deletion factor rule database 206 also includes rules that vary based on seasonal factors, such as observed trends in viewership during the fall lineup versus relatively lower viewership trends during the summer months. Without limitation, deletion factors in the example deletion factor rule database 206 may also differ based on the type of media displayed to the audience member(s). For example, deletion factors for a time period in which several sitcom programs are broadcast may be relatively higher, particularly when there are no volume changes, channel scans, and/or other evidence of active viewing. However, deletion factors for a time period in which a full-length movie is being broadcast may be lower tinder the assumption that the audience members are engaged in the program despite no indication(s) of channel-surfing and/or volume changes.

Still further, some deletion factors may be configured and/or implemented that tolerate relatively short periods of uninterrupted viewing time, yet still consider such short sessions valuable. For example, a relatively short uninterrupted viewing duration of fifteen minutes from 6:01 PM to 6:15 PM may be associated with a relatively low deletion factor when the type of media displayed is a local news program.

The example bias minimizer 208 of FIG. 2 employs at least one formula for relatively longer sessions that result in deletion of a portion of minutes. Random start minutes may be used to further minimize any bias effects that may occur. Without limitation, example Equation 1 shown below may be used by the bias minimizer 208. However, example Equation 1 is shown as an example, and any other equation (s) may be employed by the bias minimizer 208.

S=rand(0,1)×(1−P_{T})×M_{T} Equation 1.

In example Equation 1 above, P_{T} represents a deletion portion time factor, such as those shown in column 306 of FIG. 3, and M_{T} represents a session length in minutes (e.g., a threshold duration), such as those session lengths shown in column 304 of FIG. 3. As described above, values for P_{T} were obtained from previous analysis and trending information based on people meter data 106. However, the user may edit the deletion factor rule database 206 to employ any other desired rules and/or heuristics. Although the deletion factors described above differ based on whether the broadcast media is a sitcom, a movie, or a news program, other types of deletion factors may additionally or alternatively be employed. For example, deletion factors may also vary based on genre.

To illustrate how the example deletion factor engine 110 operates in view of the bias minimizer 208, assume that the session extractor 202 receives a session having a length of 237 minutes. Also assume that this example session begins at 5:21 P.M. and ends at 9:18 P.M. As described above, because the received session is longer than the session length threshold 304 for the time period of 5:21 P.M. (see row 312 of FIG. 3, which assigns a session threshold of 60 minutes), the session segregator 204 invokes the bias minimizer 208 to execute a deletion equation, such as example deletion Equation 1. The example deletion factor (Pr) shown in the example deletion factor rules 300 at 5:21 P.M. is 0.49. This results in a deletion magnitude of 121 minutes (i.e., (237 minutes)×(1-0.49)). Assuming that a random number generator produces a random value of 0.16, Equation 1 results in a retention period of 19 minutes (i.e., (0.16)×(121)). The retention period of 19 minutes spans between the start time of 5:21 P.M. through 5:40 P.M. Behavior data collected during the retention period is considered valid and retained. Additionally, 121 minutes are deleted beginning at 5:40 P.M., thereby resulting in a deletion period spanning through 7:41 P.M. Behavior data associated with the deletion period is considered invalid and discarded. Finally, behavior information acquired between 7:41 P.M. and 9:18 P.M. is also retained to consume the remainder of the original 237 minute session.

Determining which behavior data to retain from the set-top boxes 104 and purging any associated private data from the retained behavior data constitutes a first of four stages to enable one or more example methods and/or example apparatus to model set-top box data. A second stage includes imputing household and persons characteristics to the behavior data, while a third stage includes calculating viewing probabilities/factors for household audience members. While these first three example stages facilitate, in part, the ability to generate viewing probabilities for use in the calculation of audiences, ratings, and/or reach, such viewing probabilities are representative of only televisions that are connected to an STB. In most circumstances, such representations associated with viewing data for televisions connected to an STB are sufficient for reliable viewing probabilities. However, an example fourth stage includes calculating viewing probabilities/factors with viewing behavior associated with televisions not connected to an STB (i.e., non-STB viewing data 113), as described in further detail below.

Generally speaking, the set-top box data acquired at the end of the first stage is devoid of associated demographics information and/or any other information that could be deemed private and/or confidential. Media researchers typically find that behavior data is more beneficial for making accurate and/or successful predictions/projections when it is associated with demographics information. As described above, demographics information, when associated with behavior information, may allow a media researcher and/or a market research organization to apply known and/or experimental predictive patterns and/or to apply heuristics based on demographic traits.

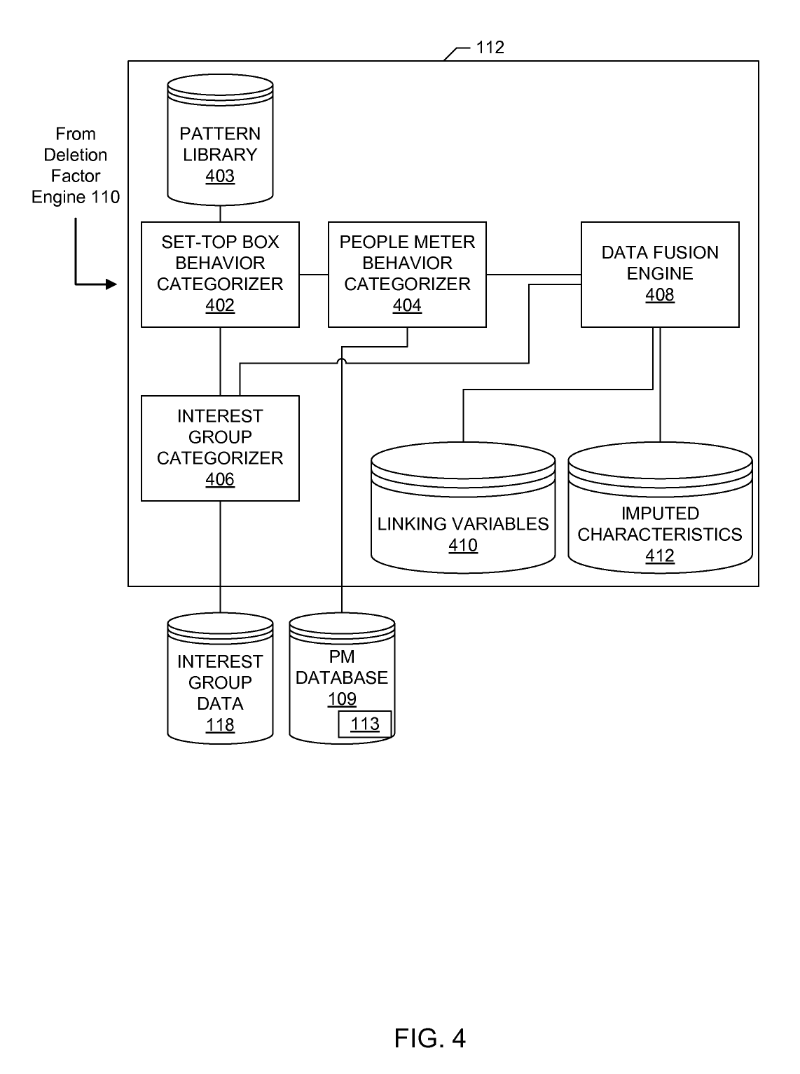

Imputing characteristics to the non-panelist set-top box data 104 is performed by the example characteristics imputation engine 112, as illustrated in FIG. 1, and in more detail in FIG. 4. In the illustrated example of FIG. 4, the characteristics imputation engine 112 includes a set-top box behavior categorizer 402, and a people meter behavior categorizer 404 communicatively connected to the people meter database 109. The example characteristics imputation engine 112 also includes an interest group categorizer 406 communicatively connected to the interest group database 118, and a data fusion engine 408 that is communicatively connected to a linking variables database 410 and an imputed characteristics database 412. Linking variables in the linking variables database 410 may include, but are not limited to, race household characteristic(s), language household characteristic(s), household size characteristic(s), household education level characteristic(s), household marital status characteristics), and/or household income level characteristics). Output Thom the data fusion engine 408 is used for the third stage and, additionally or alternatively, for a fourth stage of the example methods and/or example apparatus to model set-top box data, as described in further detail below.

Generally speaking, data fusion is a process that links two databases at the unit level based on, in part, similarity in terms of common variables between two or more databases, such as the example PM database 109 and the STB database 111. For example, an individual non-panelist STB household 104 may be linked with a panelist household 106 based on its similarity in terms of television tuning patterns across any type(s) of television tuning occasions. One or more demographic characteristics of the linked panelist household 106 may then be carried across to the STB database 111 for the corresponding panelist household 104. Characteristics such as, for example, race, origin of head-of-household (e.g., Hispanic, non-Hispanic, etc.), and/or language(s) spoken in the household may be simultaneously imputed to the STB database 111 by the example data fusion engine 408 during the data fusion process. At least one advantage of the data fusion process is that correlations between these characteristics are preserved, and inconsistencies may be avoided (e.g., inconsistencies such as fluent Spanish speaking households classified as non-Hispanic origin).

Data fusion also allows any number of variables to be substantially simultaneously considered. Tuning patterns are typically good predictors of demographics. Demographics are typically good predictors of tuning patterns. Thus, the data fusion process facilitates a relatively high degree of reliability. However, traditional applications of data fusion typically use received demographic data to determine behavior of groups of people and/or individuals. However, the data fusion employed by the example methods and apparatus described herein operates in a reverse fashion. That is, the methods and apparatus described herein impute demographic characteristics to the behavior data, in which the behavior data is devoid of demographic information to, in part, preserve audience member privacy. On the other hand, the behavior data may not include corresponding demographics information for any other reason that was not necessarily intended. For example, demographics information may not have been collected in the first place.

Although data received from panelist households includes both behavior based data as well as associated demographics information, much additional data (on televisions with and without a corresponding STB) may be acquired from set-top boxes in non-panelist households that do not participate in a media research program. Much of the set-top box behavior data is not used by market researchers because of, in part, the significant public scorn and/or legal barriers of collecting any such information that may also include personalized information. However, the example methods and apparatus described herein allow the previously unused behavior data (i.e., behavior data from non-panelist households) to become more meaningful and valuable to media researchers and/or market research entities. In particular, fusing the behavior data for non-panelist households 104 with the behavior and demographics data for panelist households 106 permit the media researcher to impute demographic characteristics to the non-panelist households 104 based on behavioral similarities, thereby maintaining the privacy aspects with respect to the received set-top box data from those non-panelist households 104.

In the illustrated example of FIG. 4, behavior based data retained by the example deletion factor engine 110 is received by the behavior characterizer 402 of the characteristics imputation engine 112. The behavior categorizer 402 parses the received data for one or more predetermined patterns of behavior that may be used to compare against behavior patterns found in people meter data and/or data associated with an alternate interest group (e.g., a readership survey). For example, the behavior categorizer 402 may identify that the retained set-top box data (from the deletion factor engine 110) includes a threshold frequency of an audience member switching between viewing sports channels on the weekends and viewing financial channels after 3:30 P.M. on weekdays. Such patterns may be parsed from the received set-top box data based on a pattern library 403, which may include one or more template behavior patterns generated and/or designed by a user (e.g., a system administrator, a statistician, etc.), and/or based on patterns and/or trends revealed/observed with people meter data.

In the illustrated example of FIG. 4, the pattern library 403 stores patterns for which the set-top box behavior categorizer 402 searches. Some patterns may be considered standard, such as a pattern that identifies a threshold number of viewing minutes per week of a broadcast type (e.g., children's shows, news programs, sports programs, etc.). Without limitation, the pattern(s) stored in the pattern library 403 may include additional criteria of a compound nature. For example, a market entity may create a pattern to look for households exhibiting a threshold number of viewing minutes of sports channels and a threshold number of viewing minutes of financial news channels. As described in further detail below, one or more data fusions may reveal that household members that exhibit behaviors matching the example pattern are males, age 25-35, and have an average income of 125,000.

The parsed and extracted patterns are provided to the people meter behavior categorizer 404, which is communicatively connected to the people meter database 109. Upon receipt of the set-top box pattern extracted by the set-top box behavior categorizer 402, the people meter behavior categorizer 404 searches the people meter database 109 for similar behavior patterns that may have been observed in one or more of the panelist households having a PM. If a similar pattern is found, the people meter behavior categorizer 404 provides, to the data fusion engine 408, the identified behavior characteristics from the non-panelist set-top box data and the associated characteristics data (e.g., demographics) of the similar behavior patterns from the (panelist) people meter data 109. Rather than immediately determine that the identified behavior characteristic(s) of the non-panelist set-top box data is to be associated with the characteristic(s) from the people meter data, the data fusion engine 408 employs a sequential data fusion. In other words, sequential and/or stepwise data fusions are performed so that the characteristics fused in a first data fusion operation are used as hooks in a second data fusion operation. The sequential data fusions of n, n+1, n+2, etc., preserve correlations between the characteristics. For example, a first data fusion may identify tuning characteristics indicating that one or more audience members were tuned into a Spanish language program, which may suggest that a correlation indicating that household as being a Hispanic family is reasonable. Subsequent fusions may reach further to address a respondent level or unit level of information rather than an aggregate level.

At least one rationale behind sequential data fusions is that a smaller donor pool of data (e.g., panelist set-top box behavior data) may not have all the possible combinations of characteristics that exist in a larger recipient database (e.g., non-panelist behavior data). Accordingly, splitting the process up into stepwise operations creates more potential combinations and may generate a better fit with existing people meter data. Additionally, sequential data fusions may be tailored to predict particular demographics with improved precision based on differences between the tendency of viewing traits to associate with particular demographic group(s). For example, some viewing traits are better for predicting race and origin, while other traits are better for predicting presence of children. As such, sequential data fusions permit such strengths to be exploited.

In the illustrated example of FIG. 4, the data fusion engine 408 attempts to fuse non-panelist set-top box behavior data with corresponding panelist-based people meter data by looking for common variables, also known as hooks and/or linking variables 410. While data fusion may occur with respect to any number of observed trends and/or patterns, the linking variables 410 (e.g., a linking variables database) guide the data fusion engine 408 to facilitate common variable matching with respect to industry-relevant hooks (e.g., variables related to broadcast media, variables related to Internet shopping, etc.). Without limitation, the linking variables 410 may include the number of sets in a household, time tuned total, time tuned to a particular channel, time tuned to a particular network (e.g., hie Food Network, ABC, NBC, etc.), time tuned to a particular channel genre, and/or time tuned by daypart (e.g., between 1:00 to 6:00 A.M., between 4:00 to 6:00 P.M., etc.). In the illustrated example of FIG. 4, matches revealed by sequential data fusions of the data fusion engine 408 are imputed with corresponding characteristics that were part of the people meter data. Such imputed characteristics may be saved to an imputed characteristics database 412 and/or provided to the viewing probability engine 114. Imputed characteristics may include, but are not limited to, African American households, Spanish language households, Hispanic origin households, households with members having a college education, gender of head of household, marital status, and/or age(s) of household member(s).

While the example people meter database 109 is illustrated as an example data set with which a data Fusion may allow characteristic imputation of a second data set having no corresponding demographic information, the example characteristics imputation engine 112 may also employ additional and/or alternate interest group data 118 and/or data associated with non-STB viewing data 113 when performing data fusion(s). The media researcher and/or marketing entity may have developed, acquired, and/or otherwise procured any number of alternate data sets related to a target population, activity, and/or community. For example, the media researcher may have developed one or more data sets related to a readership survey in which participant magazine selections are recorded and/or tracked in a voluntary manner. Additionally, the readership survey may also include participant demographic data, such as age, address, generally disclosed income, ethnicity, etc. Any such data sets developed, owned, acquired, and/or otherwise accessed are typically deemed more reliable when they are statistically mature and/or have sufficient data points to facilitate statistically significant projections.

If the user deems an alternate data set valuable in this manner, the data set (e.g., stored in the interest group database 118, and/or from the non-STB data 113) may be accessed by the example interest group categorizer 406. Such alternate data set(s) 118, 113 may be used instead of or in addition to the people meter database 109 when performing data fusion(s) with the data fusion engine 408. Accordingly, while the examples described herein are primarily directed toward television viewer audience analysis, the example methods and apparatus described herein are not limited thereto. For example, in the event that the example methods and apparatus described herein are used in an Internet commerce study, the first data set may be acquired through credit card transactions in which the users' personal identities and/or characteristics are purged for privacy reasons. Additionally, the example interest group data 118 may include the readership survey described above, in which magazine purchase information includes corresponding personal identities and/or characteristics of the purchaser. To take advantage of the relatively large pool of credit card purchase data, the example readership survey data set 118 may be utilized by the data fusion engine 408 to perform sequential data fusions of the readership survey data set 118 and the credit card purchase data set to impute characteristics to the credit card purchase data. As a result, valuable behavior based information may be used with associated imputed characteristics of the credit card purchase data without trampling privacy concerns.

The example viewing data model engine 108 also includes an example viewing probability engine 114 that, in part, utilizes the imputed characteristics of the set-top box data 111 and people meter data 109 to generate viewing probabilities. Unlike the calculated viewing probabilities described herein, typical viewing metrics include only a true/false or yes/no indicator to represent viewership by one or more audience members. On the other hand, one or more viewing probabilities calculated by the viewing probability engine 114 take into consideration any number of characteristics derived from the characteristic imputation engine 112 such as, but not limited to, household size, number of televisions in the household, time-of-day tuning, genre of programs viewed, sex, and/or age. For each household television, the viewing probability engine 114 calculates and allocates a probability of viewing minutes for each household audience member, which may be accumulated to derive viewership model(s).

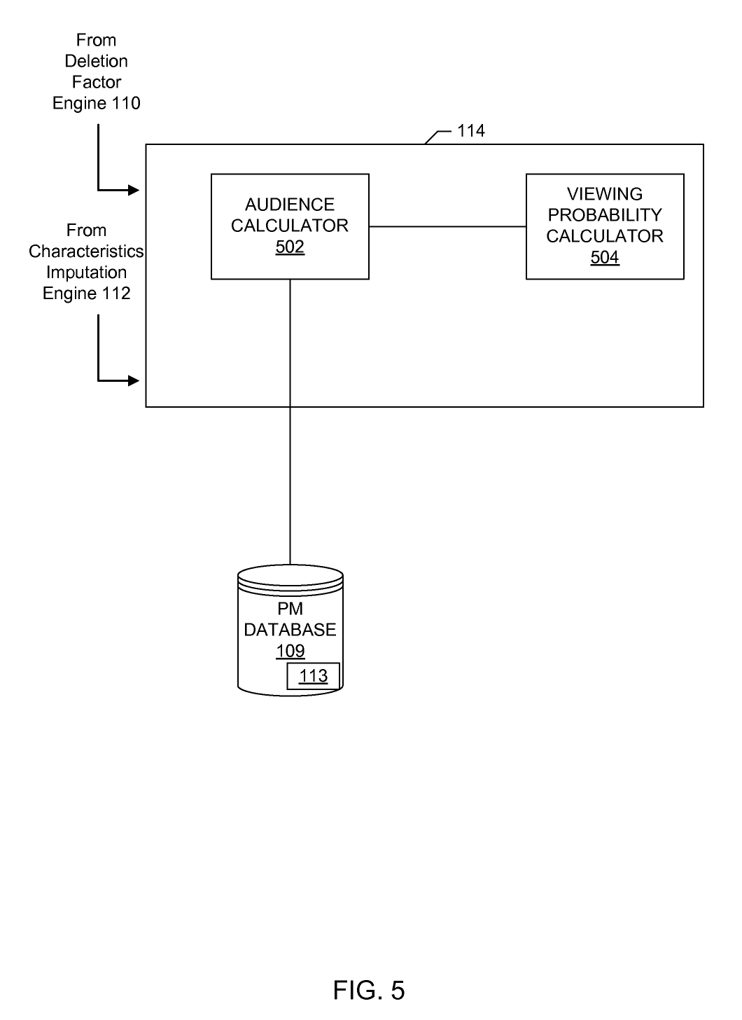

In the illustrated example of FIG. 5, the viewing probability engine 114 includes an audience calculator 502 communicatively connected to the people meter database 109, the characteristics imputation engine 112, and the deletion factor engine 110. Additionally, the example viewing probability engine 114 includes a viewing probability calculator 504 that, in part, calculates one or more viewing probabilities based on the retained viewing minutes and household tuning minutes, as described in further detail below.

Based in part on the retained set-top box data from the deletion factor engine 110, the day(s) and daypart(s) of the viewers are determined by the example audience calculator 502. Such determined day(s) and daypart(s) may be represented by days of the week having associated retained behavior data and/or hours of the day (e.g., viewing occurred between 4:00 to 6:00 P.M., viewing occurred between 12:00 to 4:00 P.M.). Each segmented daypart(s) includes associated behavior data. Additionally, the example audience calculator 502 associates corresponding characteristics with the set-top box data to allow calculation of viewers per television set. In particular, the audience calculator 502 extracts the number of television sets in the household and the corresponding household size to determine viewers per television set and/or viewers per television set per day(s) and/or per daypart(s). For example, the example audience calculator 502 may determine that each weekday between 4:00 P.M. and 6:00 P.M., the selected household has two television sets connected to corresponding STBs, three household members, and an average of 1.8 audience viewers per television set. Oilier manners of calculating the number of audience viewers per television set may be employed without limitation.

After the example audience calculator 502 determines the number of audience viewers per television set, the viewing probability calculator 504 calculates viewing probabilities by sex, by age, by genre, by daypart, and/or any combination thereof. In other words, the calculated probability is a function of many parameters (e.g., sex, age, genre, daypart, etc.) and is typically normalized to a value between zero and one. The example viewing probability calculator 504 employs Equation 2 shown below, but any other equation may be used when calculating the viewing probability (P).

$$P ( sex , age , genre , daypart ) = \frac{ViewingMinutes ( sex , age , genre , daypart )}{HouseholdTuningMinutes ( genre , daypart )} \qquad Eq . 2$$

The deletion factor engine 110 provides viewing minutes for a corresponding sex parameter, age parameter, genre parameter, and/or daypart parameter to be used with the probability equation, such as the example probability Equation 2 above. The data fusion engine 408 provides corresponding household tuning minutes based on the type of parameter (e.g., sex, age, genre, daypart, etc.). To illustrate, if the household tuning minutes for a music genre between 4:00 P.M. and 6:00 P.M. total 100 (minutes), then the viewing probability calculator 504 may determine that, for persons identified in the household that are likely between the ages of 2-17 that view for 40 minutes, the corresponding viewing probability is 0.40 (i.e., 40/100). As described above, based on the example determination that the selected household has three members, if the second member has 45 minutes of viewing time and is likely between the ages of 18-34, then the calculated probability is 0.45 (i.e., 45/100).

The example viewing probability calculator 504 continues to perform probability calculations on a person-by-person basis until the household is complete (e.g., all three audience members' probabilities are calculated). Upon completion of the probability calculation for each household member, the household probabilities are summed for the household and adjusted based on the overall viewers per set. For example, assuming that person one (P1) has a calculated viewing probability of 0.3, person two (P2) has a calculated viewing probability of 0.45, and person three (P3) has a calculated viewing probability of 0.4, then the summed probabilities are 1.15. The adjusted probability based on the viewers per set may be calculated with Equation 3 below.

$$P ( adj . ) = \frac{VPS}{Sum} \times {P}_{N} , \qquad Equation 3$$

In view of Equation 3, the adjusted probabilities for persons one, two, and three are 0.47, 0.70, and 0.63, respectively. For example, the adjusted probability of 0.47 for person one (P1) means that approximately 47% of the viewed time logged was watched by P1. Additionally, because the corresponding ages and sex of each viewer were imputed on data previously void of demographics content, market researchers may freely employ the adjusted probabilities to other groups with a greater degree of confidence. At least one benefit realized from employing probabilities rather than all-or-nothing viewed/not-viewed thresholds is that a greater sampling of behaviors are available for analysis.

Output of the adjusted probabilities and corresponding imputed characteristics are sent from the viewing probability engine 114 to the audience summary manager 116 to allow the user(s) to further analyze and use the data for their own market purposes. While the adjusted probabilities described above were discussed in terms of a single household, such calculations may be repeated in a repetitive manner from household to household. The probabilities may be calculated in aggregate across multiple homes based on parameters such as, for example, zip code, region, metropolitan area, state, etc. Calculation methodologies of any type may realize the benefits of the calculated viewing probabilities including, but not limited to, calculating audiences, calculating ratings, and calculating reach.

While the example apparatus and methods described above facilitate the generation of viewing probabilities for households having one or more televisions respectively connected to one or more set-top boxes, not all televisions within a household necessarily have a corresponding STUB connected thereto. A more complete understanding of television tuning within households includes consideration of tuning behavior with televisions not connected to a corresponding set-top box. As described above, the example system 100 includes a representative sample of thousands of households in the geographic area of interest (e.g., Germany, the U.K., the United States, etc.), and measures, among other things, usage of television sets that do not have return path capability (i.e., those television sets in a household that are not connected to an STB). The viewing data from such stand-alone televisions is utilized by the example characteristics imputation engine 112 to impute the presence of stand-alone televisions in the larger universe of interest. In particular, the example data fusion engine 408 of the characteristics imputation engine 112 performs one or more data fusions with the stand-alone television data from the PM database 109 to impute the presence of stand-alone televisions for households within the STB database 111. Additionally, the data fusion imputes viewing behavior on the stand-alone televisions to the households within the STB database 111. Upon completion of one or more data fusions by the characteristics imputation engine 112 in view of stand-alone televisions, the example viewing probability engine 114 may operate in a manner as described above in view of FIG. 5 to calculate viewing probabilities.

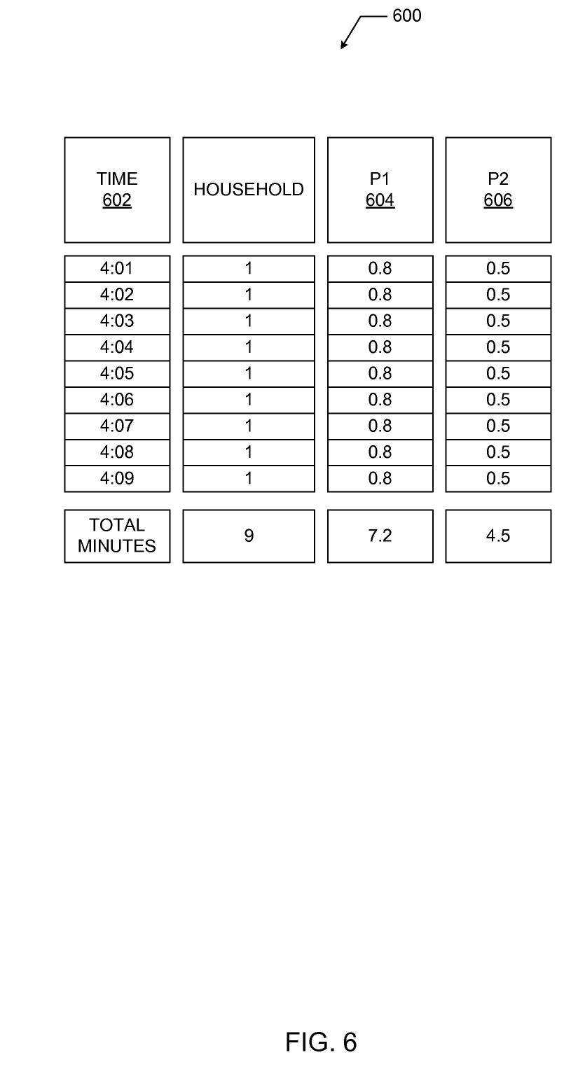

Calculated viewing probabilities are used to further calculate, for example, audiences, reach, and/or gross rating point estimates for persons (unit level) and/or households. As shown in FIG. 6, the audience summary manager 116 employs a calculated viewing probability for a male age 25-34 and a calculated viewing probability for a female age 18-24 to further calculate an audience between 4-01 PM and 4:09 PM. In the illustrated example of FIG. 6, a quarter-hour segment 600 of data was compiled for a household containing a male P1 (person 1, age 25-34) and a female P2 (person 2, age 18-24). An example time column 602 lists rows of time having minute-level resolution, in which each row of time within the column 602 corresponds to a calculated viewing probability. In particular, the quarter-hour segment 600 includes a P1 (person 1) column 604 and a P2 (person 2) column 606. In the illustrated example of FIG. 6, the calculated probability, during the selected quarter-hour between 4:01 PM and 4:15 PM, is 0.8 for P1 and 0.5 for P2. While these are example probability values to illustrate at least one audience calculation, other calculated values may result based on, for example, different session lengths, different household member ages, and/or different media program types. For example, the probability of a 6-11 year old viewing a general entertainment channel will likely be higher during the 6:00 PM to 8:00 PM slot than between the 11:00 PM to 1:00 AM slot.

Continuing with the example quarter-hour segment 600 shown in FIG. 6, P1 accumulates 7.2 minutes, P2 accumulates 4.5 minutes, and the household accumulates a total of 9 minutes of data during the fifteen minute period. Accordingly, the corresponding household rating, P1 rating, and P2 rating may be calculated via equations 4, 5, and 6, respectively.

$$\begin{matrix}HouseholdRating = \frac{AccumulatedMinutes}{SegmentMinutes} \times 100 . & Equation 4 \\ {P}_{1} Rating = \frac{{AccumulatedP}_{1} Minutes}{SegmentMinutes} \times 100. & Equation 5 \\ {P}_{2} Rating = \frac{{AccumulatedP}_{2} Minutes}{SegmentMinutes} \times 100. & Equation 6\end{matrix}$$

Applying equations 4, 5, and 6 above to the example data of the quarter-hour segment 600 results in a household rating of 60, a P1 rating of 48, and a P2 rating of 30. Unlike conventional techniques of accumulating minutes viewed within a household, in which a household member is associated with a strict yes/no (e.g., TRUE/FALSE, 0/1, etc.) for each minute within a segment, the example methods and apparatus described herein avoid such rigid constraints by employing the example audience summary manager 116 of the viewing model engine 108 to generate unit level viewing probabilities for each minute within the segment.

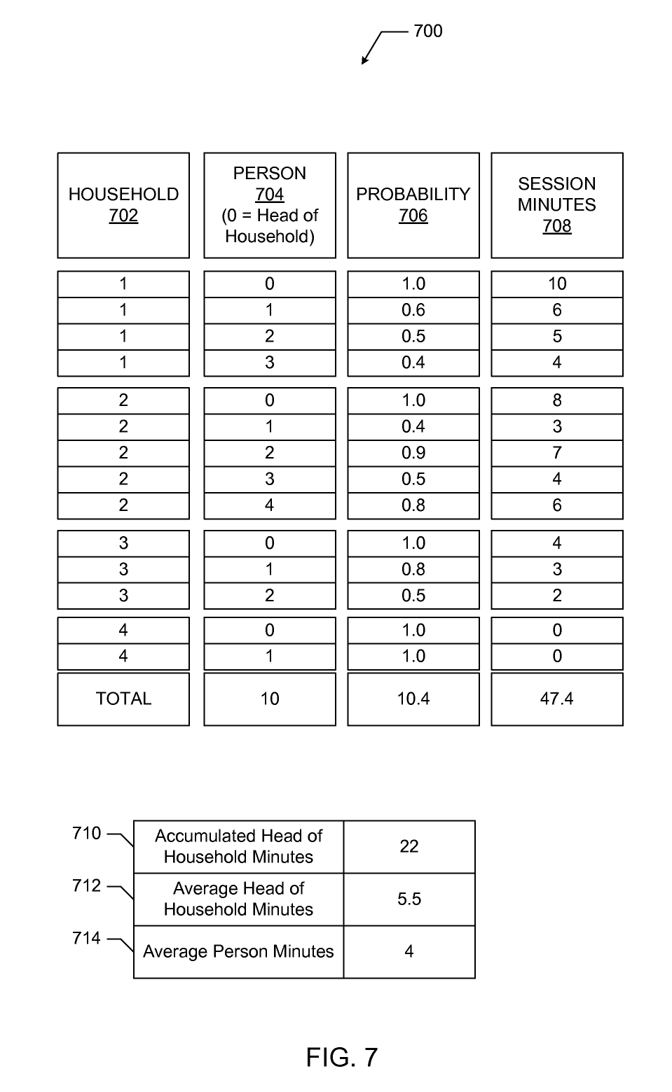

The example audience summary manager 116 may also employ any type of operational techniques with the calculated unit level and/or aggregate level viewing probabilities. The illustrated example of FIG. 7 includes an audience calculation 700 for four separate households. The example audience calculation 700 includes a household column 702, and a persons-in-household column 704. In particular, household #1 has a total of three members, household #2 has a total of four members, household #3 has a total of two members, and household #4 has a total of one member, which results in a grand total of ten persons. The example audience calculation 700 also includes a probability column 706 that includes a corresponding probability for each person yielding a sum total of 10.4. Additionally, the example audience calculation 700 includes a session minutes column 708 to identify the number of minutes each person was viewing. The sum total of the example session minutes column 708 is realized by adding each product of a person's probability and corresponding session minutes, thereby yielding a total session minutes value of 47.4. In the illustrated example of FIG. 7, the audience calculation 700 has, for purposes of example, an average household rating of 37, and an average person rating of 27.

In operation, the audience summary manager 116 calculates a household reach of 75% because, of the four example households of the audience calculation 700, only three households include accumulated session minutes (i.e., households “1,” “2,” and “3”). In the illustrated example of FIG. 7, persons reach is calculated via equation 7 below.

$$PersonsReach = PersonsRating \times \frac{AverageHouseholdRating}{HouseholdReach} . \qquad Equation 7$$

Additionally, the example audience summary manager 116 may also calculate other household metrics of interest including, but not limited to, accumulated bead of household minutes 710, average head of household minutes 712, and/or an average household persons minutes 714.

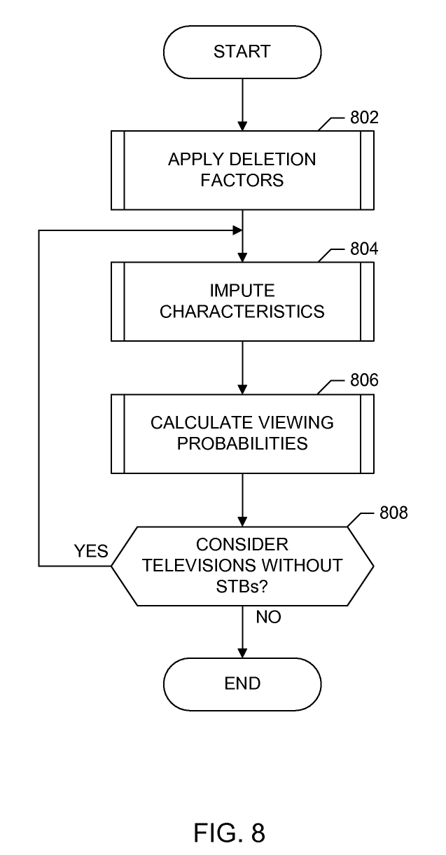

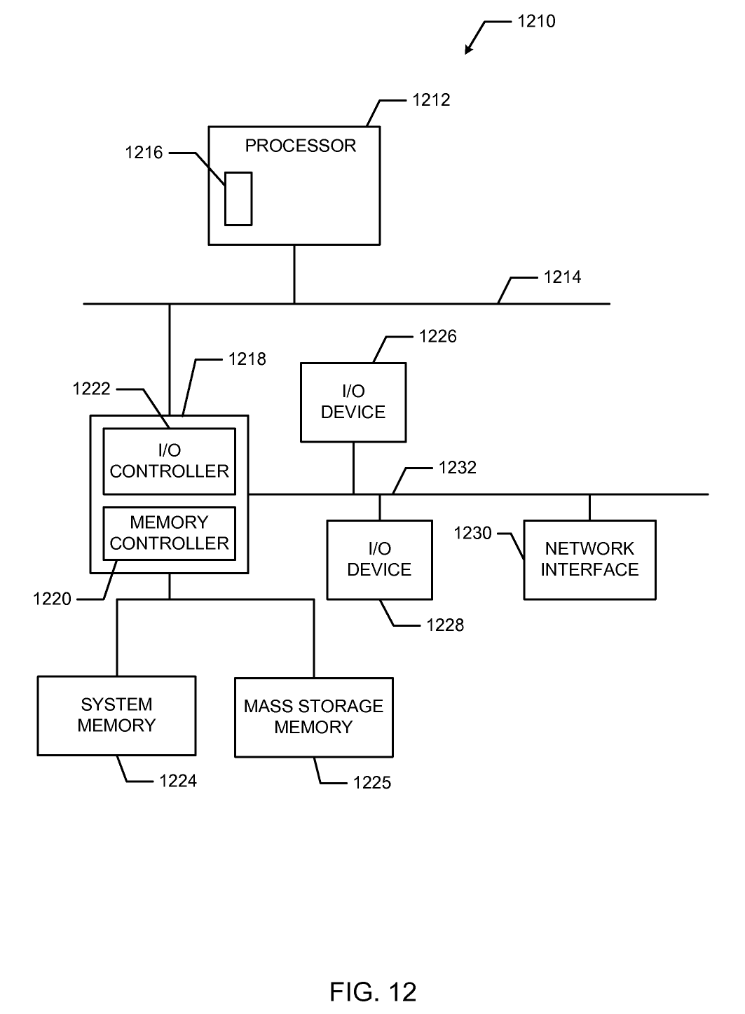

Flowcharts representative of example machine readable instructions for implementing the system 100 of FIGS. 1, 2, 4 and 5 are shown in FIGS. 8-11. In this example, the machine readable instructions comprise one or more programs for execution by one or more processors such as the processor 1212 shown in the example processor system 1210 discussed below in connection with FIG. 12. The program(s) may be embodied in software stored on a tangible medium such as a CD-ROM, a floppy disk, a hard drive, a digital versatile disk (DVD), or a memory associated with the processor 1212, but the entire program and/or parts thereof could alternatively be executed by a device other than the processor 1212 and/or embodied in firmware or dedicated hardware. For example, any or all of the deletion factor engine 110, the characteristics imputation engine 112, the viewing probability engine 114, the session extractor 202, the session segregator 204, the bias minimizer 208, the set-top box behavior categorizer 402, the people meter behavior categorizer 404, the interest group categorizer 406, the data fusion engine 408, the audience calculator 502, and/or the viewing probability calculator 504 could be implemented (in whole or in part) by any combination of software, hardware, and/or firmware. Thus, for example, any of the example deletion factor engine 110, the characteristics imputation engine 112, the viewing probability engine 114, the session extractor 202, the session segregator 204, the bias minimizer 208, the set-top box behavior categorizer 402, the people meter behavior categorizer 404, the interest group categorizer 406, the data fusion engine 408, the audience calculator 502, and/or the viewing probability calculator 504 could be implemented by one or more circuit(s), programmable processor(s), application specific integrated circuit(s) (ASIC(s)), programmable logic device(s) (PLD(s)) and/or field programmable logic device(s) (FPLD(s)), etc. Wen any of the appended claims are read to cover a purely software implementation, at least one of the example deletion factor engine 110, the example characteristics imputation engine 112, the example viewing probability engine 114, the example session extractor 202, the example session segregator 204, the example bias minimizer 208, the example set-top box behavior categorizer 402, the example people meter behavior categorizer 404, the example interest group categorizer 406, the example data fusion engine 408, the example audience calculator 502, and/or the example viewing probability calculator 504 are hereby expressly defined to include a tangible medium such as a memory, a DVD, a CD, etc. Further, although the example program is described with reference to the flowchart illustrated in FIGS. 8-11, many other methods of implementing the example system 100 may alternatively be used. For example, the order of execution of the blocks may be changed, and/or some of the blocks described may be changed, divided, eliminated, and/or combined.

The program of FIG. 8 begins at block 802 where the example system 100 applies deletion factors to received set-top box data. Additionally, because some of the received set-top box behavior data (i.e., the data from the non-panelist households 104) is devoid of demographics information and/or other characteristics indicative of the household members' identities, the system 100 imputes characteristics to that set-top box data (block 804) before calculating viewing probabilities (block 806) for the persons and/or groups imputed to the set-top box behavior data. Additionally or alternatively, the system 100 may calculate viewing probabilities in view of viewership behavior associated with televisions not capable of return path data (block 808). In the event that non-STB data is applied with one or more data fusion(s), the example data fusion engine 408 employs non-STB viewing data 113 from the PM database 109.

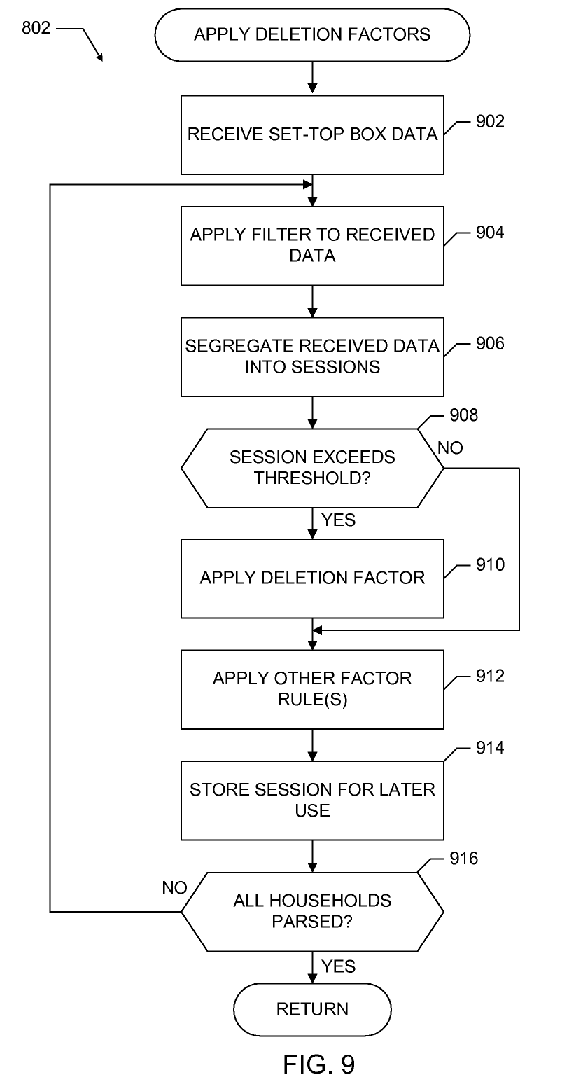

In the illustrated example of FIG. 9, application of deletion factors (block 802) is described in further detail. The example set-top box data from the non-panelist households 104 is received by the session extractor 202 from the set-top box database 111 (block 902). Such received data may be segregated/filtered on a per-household basis upon receipt by the extractor 202 (block 904), but is otherwise not arranged in any particular order. More specifically, the received data may include data associated with the non-panelist household 104 such as, but not limited to, household member names, set-top box identification string(s), geographic indicators (e.g., city, state, zip, etc.), and/or number of household members. In the event that any behavior-based set-top box data for non-panelist households contains information that may be deemed personal and/or private, the example session extractor 202 removes it (block 904).

While behavior-based set-top box activity is useful for the user (e.g., a media researcher, a market research entity, etc.), some of the behavior-based data may be deemed unnecessary, sporadic, and/or non-useful. For example, relatively short tuning periods may be indicative of channel surfing rather than consumption of the programming content that is broadcast over the tuned-channel. As a result, the session segregator 204 extracts one or more sessions of the received set-top box data that are deemed useful as defined by, for example, the deletion factor rule database 206 (block 906). The term session is used herein to identify an uninterrupted unit of viewing time by an audience member and, as described above, example threshold values for defining such sessions are shown in FIG. 3. If a received session exceeds a threshold duration (block 908), such as the example session length threshold 304 of FIG. 3, then the deletion factor engine 110 applies a deletion factor (block 910) with the bias minimizer 208, as described above. On the other hand, even if the received session does not exceed a threshold duration (block 908), the process 802 advances to block 912 to apply other factor rules from the deletion factor rule database 206 that may be appropriate. For example, deletion factor rules may be applied based on the time-of-day in which the audience member was viewing, the day of the week in which the audience member was viewing, and/or the type of program the audience member was viewing (e.g., household members may focus better on news programs versus game-shows that may be tuned out of habit).

Sessions having applied deletion factors are stored for later use (block 914) in, for example, a memory of the deletion factor engine 110, the deletion factor rule database 206, and/or system memory 1224 as shown in FIG. 12. Upon completion of determining sessions and corresponding deletion factors for each household, the example deletion factor engine 110 determines if all households for a given subset of received set-top box data from the STB database 111 has been parsed (block 916). If not, control returns to block 904, otherwise control advances to block 804 to impute demographic characteristics on the received set-top box behavior data.

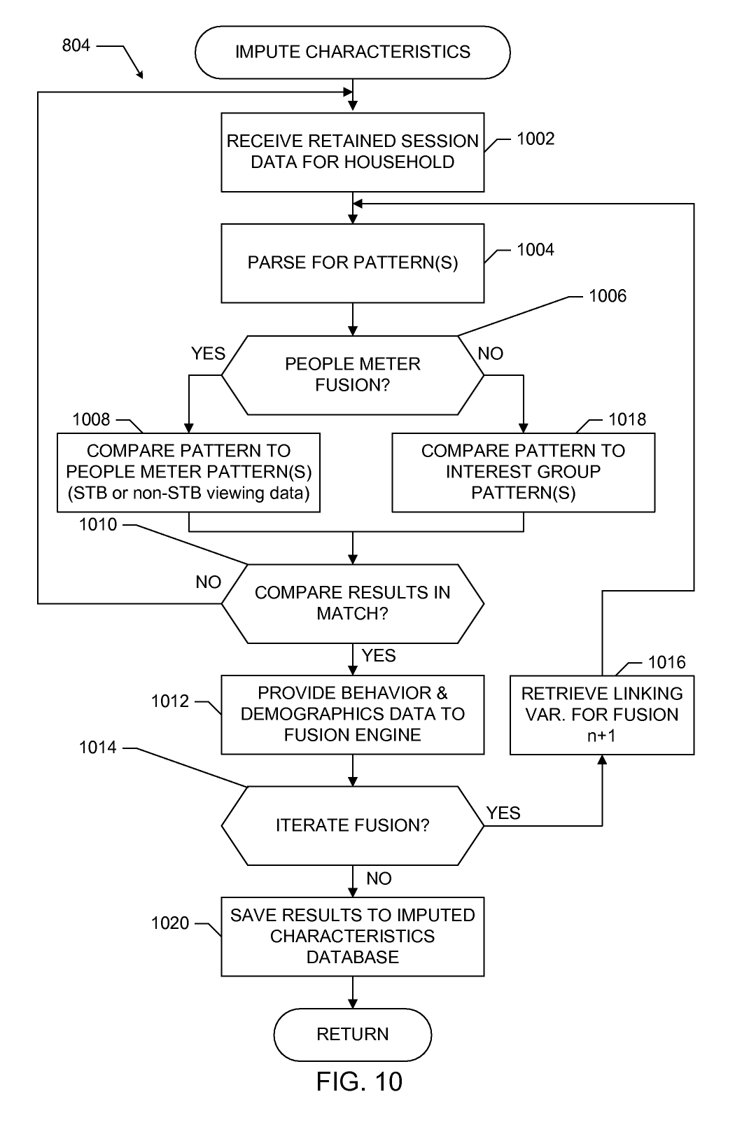

In the illustrated example of FIG. 10, imputation of characteristics to non-panelist behavior-based data devoid of such characteristics (block 804) is described in further detail. The retained session data from the deletion factor engine 110 is received by the characteristics imputation engine 112 on a household-by-household basis (block 1002). In particular, the set-top box behavior characterizer 402 receives the retained session data (block 1002) and parses for predetermined patterns of interest (block 1004). Patterns of interest may be defined by people meter data, such as from the people meter database 106 and/or from alternate data sources, such as the interest group data 118. As described above, a pattern of interest may include, but is not limited to, an observation that one or more household members turns on the set-top box at a particular time each weekday/weekend, or tunes to a particular channel, or leaves the set-top box turned on for a particular duration, etc.

In the illustrated example of FIG. 10, the characteristics imputation engine 112 performs one or more data fusions of the retained set-top box behavior data and a separate data source having information related to demographics and/or personal characteristics of groups of audience members (e.g., Nielsen People Meter® data). The characteristics imputation engine 112 determines whether the data fusion is to be performed with people meter data or an alternate data set having characteristics information indicative of, for example, demographics (block 1006). In the event that the data fusion should occur with people meter data, the people meter behavior categorizer 404 compares the identified patterns of behavior in the non-panelist set-top box data with similar patterns that may exist in the people meter database 109 (block 1008). If a corresponding match is found (block 1010), the set-top box data and the characteristics from the people meter data associated with the matching pattern are provided to the example data fusion engine 408 (block 1012). To illustrate further, the pattern from the set-top box data may be that of a household viewing a Spanish speaking channel, which is compared to the people meter data from the people meter database 106. As this example identifies the Spanish speaking channel pattern as a match, the characteristics of the audience members from the people meter data are imputed to the non-panelist set-top box behavior data, which was previously devoid of any associated personalized characteristic information.

While this first iteration of a data fusion by the example data fusion engine 408 has facilitated an understanding that the non-panelist set-top box data is associated with a Spanish speaking household, no corresponding information has been imputed related to the individual household members that may have been watching that program. In other words, at this point there is no indication whether the audience members are adults, children, male, female, etc. As such, the example characteristics imputation engine 112 permits sequential and/or iterative data fusions to impute characteristics from an aggregate (broad) level to a more precise (unit) level. In the illustrated example of FIG. 10, the data fusion engine 408 determines whether to proceed with another data fusion iteration (block 1014) and retrieves linking variables (“hooks”) from the linking variables database 410 (block 1016). As described above, the linking variables may include, but are not limited to the number of sets in a household, time (e.g., hours, minutes, seconds) tuned total, time tuned to a particular channel, time tuned to a particular network, time tuned to a particular channel genre, and/or time tuned by daypart. Such hooks may serve as a guide to the data fusion engine 408, the people meter behavior categorizer 404 when searching for additional patterns of interest, and/or the example interest group categorizer 406 when searching for additional patterns of interest.

Accordingly, a subsequent iteration may build upon the first iteration by narrowing down, for example, the particular Spanish speaking program that was viewed by the audience member(s). In the event that the set-top box behavior data indicates a children's program was being watched by the audience member(s), then the example data fusion engine 408 may fuse the set-top box data and the people meter data to impute an age category on the Spanish speaking audience members. In this example scenario, the audience members are likely to be children. Further, another subsequent data fusion iteration may occur that narrows the child's age range by, for example, looking for the time-of-day that the children's program was aired. Building on the previous example, a third data fusion iteration may reveal that children's programs that are broadcast between 4:00 P.M. and 6:00 P.M. are typically associated with older children that attend school, while children's programs that are broadcast between 12:00 P.M. and 2:00 P.M. are typically associated with much younger children that do not attend school. The media researcher may find this distinction particularly important to justify whether advertisements related to diapers and/or baby formula are warranted, or whether advertisements related to lunch snacks and/or breakfast cereals are more appropriate.

Returning briefly to block 1006, in the event that the data fusion should occur with alternate interest group data, the example interest group categorizer 406 compares patterns of behavior in the set-top box data with similar patterns that may exist in the interest group data 118 (block 1018). As described above, the interest group data 118 may be any subset of data that includes behaviors and associated demographics. An example subset of such data may include a readership survey in which participants' magazine purchase behaviors are monitored and classification data is obtained including, but not limited to, name, address, profession, family size, ethnicity, etc.

If a corresponding match is found (block 1010), the behavior based data (e.g., set-top box data 104) and the characteristics (e.g., demographics) from the interest group data 118 associated with one or more matching pattern(s) are provided to the example data fusion engine 408 (block 1012). After performing a data fusion of the data set(s) (block 1012), additional data fusion iteration(s) may be performed as described above (block 1014). However, if no further data fusions are to be performed (flock 1014), then data fusion results are saved for later use (block 1020).

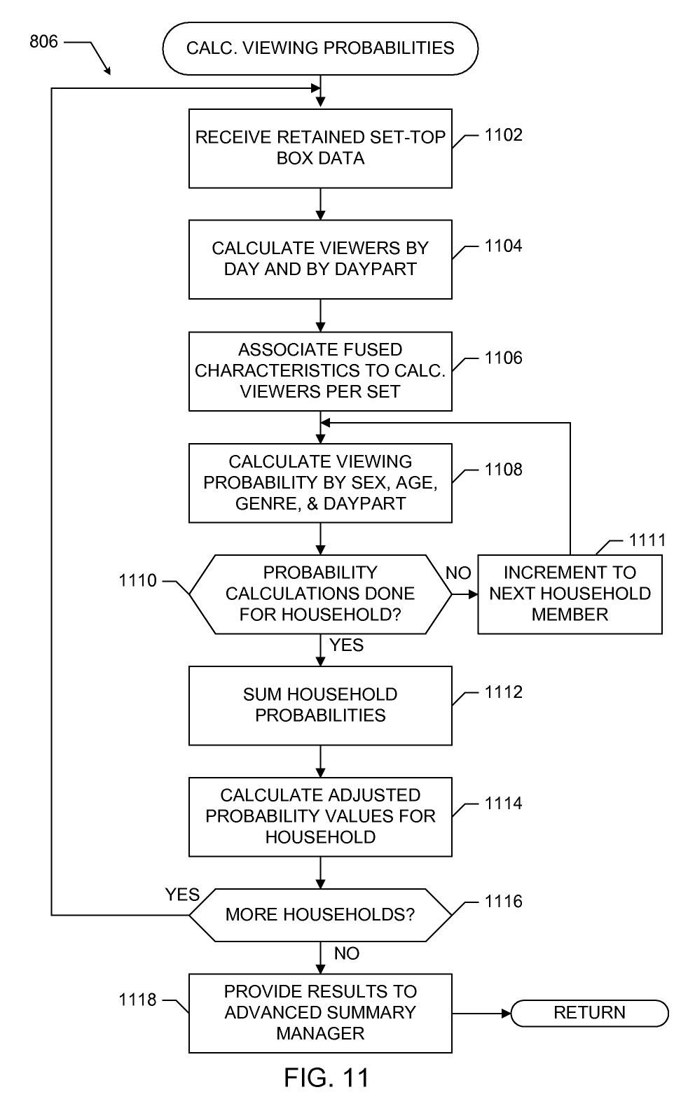

In de illustrated example of FIG. 11, calculation of viewing probabilities of household member(s) (block 806) is described in further detail. Fused data, which includes non-panelist set-top box behavior information, is received by the example audience calculator 502 (block 1102). For each available household, viewers by day (e.g., how many viewers for each Monday, for each Tuesday, etc.) and/or viewers by daypart (e.g., how many viewers between the hours of 12:00 P.M. and 2:00 P.M., how many viewers between the hours of 4:00 P.M. and 6:00 P.M., etc.) are calculated (block 1104). This calculation may be realized in terms of a decimal number, such as, for example, a calculated value of 1.8 viewers per set for weekdays between 4:00 P.M. and 6:00 P.M. in a household having 2 television sets and 3 household members. The viewing probability calculator 504 associates this calculation with associated demographics information (block 1106), such as provided by the people meter database 109, to calculate viewing probabilities for a household member by sex, age, genre, and/or daypart (block 1108). If additional household members still require a viewing probability calculation (block 1110), the example viewing probability engine 114 repeats the calculation (block 1108) in view of the imputed characteristics for the next household member (block 1111) previously saved in the imputed characteristics database 412 and/or other data storage (e.g., the system memory 1224 of FIG. 12).

If all household members' viewing probabilities have been calculated (block 1110), they are summed (block 1112) and an adjusted probability value for each household member is calculated based on overall viewers-per-set (block 1114). As described above, example Equation 3 may be employed to calculate the adjusted probability. If additional households are available from the received fused data (block 1116), in which each household has at least one audience member, the process returns to block 1102 to calculate viewing probabilities for those household member(s). Otherwise, the viewing probability calculations are provided to the example audience summary manager 116 (block 1118) to allow the user(s) to employ one or more calculation method(s). As described above, calculation methods that may be realized in view of the viewing probability calculations include, but are not limited to, calculating ratings of broadcast programming, calculating advertising effectiveness, and/or calculating reach.

FIG. 12 is a block diagram of an example processor system 1210 that may be used to execute the example machine readable instructions of FIGS. 8-11 to implement the example systems, apparatus, and/or methods described herein. As shown in FIG. 12, the processor system 1210 includes a processor 1212 that is coupled to an interconnection bus 1214. The processor 1212 includes a register set or register space 1216, which is depicted in FIG. 12 as being entirely on-chip, but which could alternatively be located entirely or partially off-chip and directly coupled to the processor 1212 via dedicated electrical connections and/or via the interconnection bus 1214. The processor 1212 may be any suitable processor, processing unit or microprocessor. Although not shown in FIG. 12, the system 1210 may be a multi-processor system and, thus, may include one or more additional processors that are identical or similar to the processor 1212 and that are communicatively coupled to the interconnection bus 1214.

The processor 1212 of FIG. 12 is coupled to a chipset 1218, which includes a memory controller 1220 and an input/output (I/O) controller 1222. As is well known, a chipset typically provides I/O and memory management functions as well as a plurality of general purpose and/or special purpose registers, timers, etc. that are accessible or used by one or more processors coupled to the chipset 1218. The memory controller 1220 performs functions that enable the processor 1212 (or processors if there are multiple processors) to access a system memory 1224 and a mass storage memory 1225.

The system memory 1224 may include any desired type of volatile and/or non-volatile memory such as, for example, static random access memory (SRAM), dynamic random access memory (DRAM), flash memory, read-only memory (ROM), etc. The mass storage memory 1225 may include any desired type of mass storage device including hard disk drives, optical drives, tape storage devices, etc.

The I/O controller 1222 performs functions that enable the processor 1212 to communicate with peripheral input/output (I/O) devices 1226 and 1228 and a network interface 1230 via an I/O bus 1232. The I/O devices 1226 and 1228 may be any desired type of I/O device such as, for example, a keyboard, a video display or monitor, a mouse, etc. The network interface 1230 may be, for example, an Ethernet device, an asynchronous transfer mode (ATM) device, an 802.11 device, a digital subscriber line (DSL) modem, a cable modem, a cellular modem, etc. that enables the processor system 1210 to communicate with another processor system.

While the memory controller 1220 and the I/O controller 1222 are depicted in FIG. 12 as separate functional blocks within the chipset 1218, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method of calculating a behavior probability comprising:
receiving a first set of non-panelist behavior data;
receiving a second set of panelist set-top box behavior data, the second set being associated with demographic data;
identifying at least one behavior pattern common to the first and second sets of behavior data; and
fusing data associated with the at least one behavior pattern from the first set with data associated with the at least one behavior pattern from the second set to impute at least one demographic characteristic from the second set to the first set and generate a quantity of household tuning minutes.

2. A method as defined in claim 1, further comprising calculating a behavior probability based on a ratio of retained behavior minutes from the first set of behavior data and the household tuning minutes.

3. A method as defined in claim 2, further comprising calculating at least one of reach, audience, or gross rating point based on the calculated behavior probability.

4. A method as defined in claim 1, wherein receiving the first set of behavior data further comprises extracting at least one session from the first set.

5. A method as defined in claim 4, wherein extracting at least one session comprises identifying an uninterrupted session length.

6. A method as defined in claim 4, further comprising applying at least one deletion rule to the extracted at least one session.

7. A method as defined in claim 6, wherein the at least one deletion rule applies a deletion factor to the extracted at least one session, the deletion factor to at least one of retain the uninterrupted session, delete the uninterrupted session, or retain a portion of the uninterrupted session.

8. A method as described in claim 6, wherein the at least one deletion rule is based on at least one of a session start time, a session duration, a session time-of-day, a season of year, or a type of broadcast program.

9. A method as defined in claim 1, wherein receiving the second set of behavior data further comprises receiving at least one of people meter data or interest group data.

10. A method as defined in claim 9, wherein the received people meter data comprises at least one of measured viewing behavior from a set-top box or viewing behavior from a stand-alone television.

11. A method as defined in claim 1, wherein identifying at least one behavior pattern comprises parsing the first and second sets of behavior data for at least one behavior pattern.

12. A method as defined in claim 11, wherein the at least one behavior pattern comprises at least one of a time-of-day viewing pattern, a viewed channel frequency pattern, or a day of week viewing pattern.

13. A method as defined in claim 1, wherein fusing data further comprises applying at least one linking variable to identify at least one common link between the first and second sets of behavior data.

14. A method as defined in claim 13, wherein the at least one linking variable comprises at least one of a number of televisions in a household, an amount of total tuned time per household, an amount of time tuned to a channel, an amount of time tuned to a network, an amount of time tuned to a channel genre, or an amount of time tuned per day-part.

15. A method as defined in claim 13, wherein the at least one common link comprises at least one of a household characteristic race, a household characteristic language, a household characteristic size, a household characteristic education level, a household characteristic marital status, or a household characteristic income level.

16. A method as defined in claim 1, wherein fusing data further comprises iteratively fusing the data to impute respondent level demographics characteristics from the second set to the first set.

17. A method as defined in claim 1, further comprising, when the first set of non-panelist behavior data includes demographics information, removing the demographic information from the non-panelist set-top box data to maintain audience member privacy.

18. An apparatus to calculate a viewing probability comprising:
a deletion factor engine to apply at least one deletion factor to received non-panelist set-top box data;
a characteristics imputation engine to fuse the received non-panelist set-top box data with at least one demographic characteristic to generate fused set-top box data; and
a viewing probability engine to calculate the viewing probability for at least one audience member based on the fused set-top box data and demographics data.

19. An apparatus as defined in claim 18, wherein the deletion factor engine comprises a session extractor to extract behavior data from the received non-panelist set-top box data and to purge data indicative of demographics from the non-panelist set-top box data.

20. An apparatus as defined in claim 18, wherein the deletion factor engine further comprises a session segregator to apply deletion factor rules to the received non-panelist set-top box data.

21. An apparatus as defined in claim 18, wherein the deletion factor engine comprises a bias minimizer to apply at least one deletion equation to a viewing session.

22. An apparatus as defined in claim 18, wherein the characteristics imputation engine comprises a set-top box behavior categorizer to parse the received set-top box data for at least one behavior pattern.

23. An apparatus as defined in claim 22, wherein the characteristics imputation engine comprises a people meter behavior categorizer to search for at least one match from the set-top box behavior categorizer.

24. An apparatus as defined in claim 23, wherein the characteristics imputation engine further comprises a fusion engine to impute demographic characteristics from the people meter behavior categorizer to behavior data from the set-top box behavior categorizer.

25. An apparatus as defined in claim 18, wherein the viewing probability engine comprises an audience calculator to calculate a number of audience viewers by at least one of day or daypart based on the fused set-top box data.

26. An apparatus as defined in claim 25, further comprising a viewing probability engine to calculate the viewing probability based on at least one viewing probability equation.

27. An apparatus as defined in claim 26, wherein the at least one viewing probability equation is to calculate a viewing probability based on total viewing minutes per demographic group and total viewing minutes per household.

28. An article of manufacture storing machine readable instructions which, when executed, cause a machine to:
receive a first set of non-panelist behavior data;
receive a second set of panelist set-top box behavior data, the second set being associated with demographic data;
identify at least one behavior pattern common to the first and second sets of behavior data; and
fuse data associated with the at least one behavior pattern from the first set with data associated with the at least one behavior pattern from the second set to impute at least one demographic characteristic from the second set to the first set and generate a quantity of household tuning minutes.

29. An article of manufacture as defined in claim 28, wherein the machine readable instructions further cause the machine to calculate a behavior probability based on a ratio of retained behavior minutes from the first set of behavior data and the household tuning minutes.

30. An article of manufacture as defined in claim 29, wherein the machine readable instructions further cause the machine to calculate at least one of reach, audience, or gross rating point based on the calculated behavior probability.

31-39. (canceled)
